(19) United States
(12) Patent Application Publication
(10) Pub. No.: US 2002/0184133 A1
(43) Pub. Date: Dec. 5, 2002

(54) Method and system for verifying the integrity of data in a data warehouse and applying warehoused data to a plurality of predefined analysis models

(76) Inventors: Peter J. Zangari, Fairfield, NJ (US); John Anthony Matero, New York, NY (US); Sourabh Banerji, New York, NY (US)

Correspondence Address: Clifford Chance Rogers & Wells LLP, 200 Park Avenue, New York, NY, 10166-0153, US

(21) Appl. No.: 10/084,905

(22) Filed: Feb. 28, 2002

Related U.S. Application Data
(60) Provisional application No. 60/294,754, filed on May 31, 2001.

(51) Int. Cl. G06F 17/60

(52) U.S. Cl. 705/36

(57) ABSTRACT

A method and system for verifying the integrity of data in a data warehouse and applying warehoused data to a plurality of predefined analysis models uses a data integrity system to verify the accuracy of received data and an analyitics system for applying the data and a series of models to the data. The data integrity system is configured to produce a series of diagnostic reports which identify outlier data or other data values which could indicate data errors. Diagnostic reports can include links to sub-reports that provide the data underlying summary values and links to a data editor to permit erroneous data to be directly corrected without leaving the report. The analyitics system uses the data to determine values for a library of factors. Models which are based on those factors are then applied to the data. In a particular embodiment, the data is financial data and the models are configured to provide estimates of attributes such as risk and return for various portfolios. Data and model integrity is further verified by comparing estimates for portfolio performance generated by the analyitics system with official performance values for the portfolio provided by an outside source. A reporting system can also be provided to generate risk, return, and other portfolio analysis reports.

### CROSS-REFERENCE TO RELATED APPLICATIONS

This application claims priority under 35 U.S.C. §119 to U.S. Provisional Application Serial No. 60/294,754, filed on May 31, 2001 and entitled “Portfolio Analysis And Construction Environment For Investment Managers,” the entire contents of which is hereby expressly incorporated by reference.

### COPYRIGHT STATEMENT

This document contains material which is subject to copyright protection. The applicant has no objection to the reproduction of this patent document, as it appears in the U.S. Patent and Trademark Office patent file or records or in any publication by the U.S. Patent and Trademark Office or counterpart foreign or international instrumentalities. All remaining copyright rights whatsoever are otherwise reserved.

### FIELD OF THE INVENTION

The present invention is related to a system and method for verifying the integrity of data in a data warehouse and for applying the warehoused data to a plurality of predefined data analysis models.

### BACKGROUND

There are many environments where data is collected from multiple sources, stored in a data warehouse, and then applied to one or more models to derive properties about the data or various groupings of the data, and make predictions about future behavior, or for other purposes. In many circumstances, very large quantities of data are gathered by third parties and provided for use in the data warehouse. To insure that the modeled values are correct, it is important to verify that the received data is accurate. During a typical data integrity check, suspect data points are identified. The accuracy of the flagged data is then manually checked and the database contents updated if needed. The data analysis is often needed on a periodic basis, such as daily, and it can therefore be critical for the data integrity process to be efficient, in terms of both time and resources.

It is also not unusual for there to be several different models that are applied to the same set of underlying data to generate values for various attributes. In many circumstances, the attributes themselves are dependent on one or more common factors and there is a need to ensure consistency in the factor values used in such related models. It is also useful to be able to verify the integrity of the models themselves against a benchmark.

One type of environment in which large quantities of data are gathered and analyzed using models is a financial analysis system. Groups of financial instruments for which data is provided are defined by various portfolios and the system is used to analyze the behavior and predict the performance of these portfolios. In such a system, portfolio managers construct and modify portfolios in an effort to reach a targeted level and distribution of returns and risk. The risk and return values are determined by applying financial models to current and historical information related to the securities in the various portfolios. As will be appreciated, the accuracy of the portfolio construction is highly dependent upon the accuracy of the source data.

The process of construction and management of portfolios has two primary aspects—asset allocation and asset selection. In asset allocation, a portfolio manager determines the suitable mix of currency, fixed income and equity exposures to meet the portfolio's stated goals. Asset selection involves choosing appropriate stocks within the equity class for the portfolio. In a simple example of portfolio construction, a U.S. equity manager can make asset allocation decisions and choose among cash and U.S. equities. The asset selection decision involves selecting stocks from a “universe” of available stocks. The universe of stocks typically is a function of a benchmark that the portfolio is managed against and compared to, such as the Standard & Poors 500.

In order to successfully construct and manage a portfolio, several factors must be addressed. For investors, the portfolio construction process should be clearly defined and transparent. The generated portfolio should also have a recognizable footprint or signature which is consistent with the investment management philosophy. Also, the portfolio construction process should be replicable to the extent that the investment managers can benefit from automation, and senior management can mitigate the business risk associated with unexpected turnover.

In order to achieve these goals, a suitable portfolio construction infrastructure is needed which provides portfolio managers with current and accurate financial information as well as appropriate applications to act upon that information. Conventional portfolio management systems are built to satisfy a broad cross-section of investment professionals with varying preferences and requirements. The resulting systems, however, are often severely limited in their ability to be customized to a particular client's needs.

Conventional systems are also not well suited to process large numbers of portfolios and related information on a continual production basis. In order to manage a portfolio, it is customary to analyze financial information to derive various risk and performance factors. These factors are then applied to a portfolio via a suitable mathematical model. Investment managers often require models that are customized to mimic their investment process. However, conventional portfolio management systems assume that all investment processes are identical. Thus, the ability to process portfolios based on a number of differing investment strategies or processes is limited. Investment managers must then use multiple, separate applications in order to execute customized models.

More generally, conventional systems are not well suited to utilize the information which is gathered in ways which are not part of the original system design. Thus, for example, when multiple systems are used in order to support customized models, technical support personnel must address issues of transferring data between these systems and ensuring data integrity and timeliness. The lack of ease with which the gathered information can be used also makes it difficult to research and test new models and methods of data analysis since it may not be possible to run the model in development against the same data set as the production models in a timely manner. It is also difficult to customize the application to meet specific user needs, such as by adding a newly developed model, without having to alter the application source code.

Another drawback present in conventional systems is that the determined risk and performance attributions are measured using separate processes, each acting on its own underlying set of data. For example, a financial services provider may use systems from BARRA to monitor risk and systems from Wilshire Associates to provide portfolio managers and clients with performance attribution analysis. Because separate systems are used, the factors underlying the models used to monitor risk and performance may differ, in terms of source data, manner of derivation, and final value. As a result, there can be inconsistencies between the risk analysis and the performance attribution.

### SUMMARY OF THE INVENTION

These and other deficiencies are addressed by the present invention which provides a comprehensive database and analysis environment in which large quantities of supplied data can be efficiently verified to ensure integrity and the data applied to one or more models to derive attributes of interest for various groups of data. A particular implementation of the invention is a portfolio analysis and construction environment (referred to herein as “PACE”) that supports active and quantitative portfolio management and risk management. However, various aspects of the invention can also be used in environments which gather and analyze data for other purposes.

A typical embodiment of PACE is comprised of three major components: (a) a data integrity system which populates a data warehouse with validated financial information; (b) an analyitics system which processes the financial information to derive various risk, return, and exposure factors and applies a series of financial models to the data in the warehouse; and (c) a reporting system which produces risk and return attribution reports for use by portfolio managers. In the preferred implementation, the three components are operated as part of an integrated system. However, the components can also be operated on an individual basis and used, for example, to replace discrete functionality in a legacy system.

In operation, PACE receives financial data, such as pricing and corporate action data, provided by one or more market data sources and stores this data in the data warehouse. The warehoused data can be accessed via intranet, Internet, or software-based interfaces, as appropriate or desired by the system designer and operator. Thus, the system can be implemented in a distributed manner or some or all components can be centralized. Preferably, before the raw financial data is approved for use by other system components, such as the reporting system, the data is processed by the data integrity system. During this processing, a series of diagnostic reports are generated which highlight potentially erroneous data points and allow operators to make corrections as needed.

Summary diagnostic reports, such as volatility evaluations, are provided and can contain links to underlying detailed reports showing the data used to generate the summary values. When a suspect data value is present, a user can select the link associated with that value and “drill-down” to determine the source of the error. According to one aspect of the invention, data points in diagnostic reports contain links to a data editor that is connected to the data warehouse. When such a data edit link is selected, an interface to the data warehouse is presented from which the user can enter a corrected value which is then used to update the value in the data warehouse. By providing direct access to the underlying data through a diagnostic report, data in the data warehouse can be easily and changed immediately upon a determination that a correction is necessary.

In addition to analyzing pricing data for individual securities to detect unusual activity which should be validated, and according to a further aspect of the invention, the data integrity system also verifies the market information indirectly by comparing valuations of one or more portfolios generated using the validated data, such as valuations generated by the analyitics component, with analogous portfolio valuations generated according to different mechanisms and/or data, and then highlighting unusually large differentials. Preferably, the comparison portfolio valuations are provided by an independent source. For example, estimated portfolio returns can be compared with an official return issued by an outside source. By utilizing this data feedback path, systemic errors in the data and modeling process can be detected and the overall operation of the data integrity and portfolio analysis process can be validated.

The analyitics system in PACE analyzes warehoused data to determine the values of various factors, such as those related to exposure, risk, and return. These factor values are then stored in a factor value database. Particular factors in the set of factors (which can be considered a factor library) are selected and used in risk and return measurement models, each of which can reflect a different investment methodology. The factor library thus provides a toolbox from which a wide variety of models can be built. Mechanisms for developing specialized or new factors can also be provided and, once such new factors are added, they can be made available for use in other models as well.

The analyitics component has access to portfolios definitions and the portfolios are associated with particular models. The analyitics system evaluates the factors used by all of the associated models and then uses these factor values when applying the models against the portfolios. Preferably, models for risk and for performance are both based upon the same factor library. This methodology ensures that models which depend on the same factor will be evaluated using the same factor value. Because conventional methodologies evaluate risk and performance values using separate platforms which can use different factor evaluation methods and source data, this factor value equivalence is not always present. By building all models from the same factor model, this source of error is eliminated.

Preferably, the portfolio-model associations are specified on a portfolio basis to provide the most flexibility. Alternatively, portfolios can be grouped into different sets, such as according to investment strategy, and the model associations defined on a per-set basis. For example, a risk model which works well for small-cap portfolios may not work well for large-cap portfolios. Similarly, one set of industry classifications may be more useful and relevant for one portfolio manager than another. Advantageously, this configuration permits different risk models to be applied to different types of accounts and strategies and account-specific risk models can be created and used in the system.

In a preferred implementation, the factor library, computed factor values, and current and historical data from the warehouse can also be made available for use in a research and/or development platform, such as a MATLAB® environment. Direct access to actual factor values, financial data, and portfolio definitions, permits new models to be easily developed, tested, and compared with prior models. In addition, newly developed models that are constructed from factors in the factor library can be easily imported into the main analyitics system.

The data generated by the analyitics system is stored and made available for use by the reporting system. The system uses the data produced by applying the various models to the portfolios to generate production reports, e.g., on a daily basis, which identify sources of risk and return for large numbers of separately managed portfolios and mutual funds. The reports are preferably made available via an Internet web page. In addition to providing reports on a per-portfolio basis, overview reports can be generated which contain data summaries for multiple separate portfolios, thus simplifying the ability to oversee and compare the performance of sets of portfolios.

Apart from the reporting system, a series of tools and utilities can also be provided and given access to the various databases containing financial data, factor values, and results of model application. The tools set provides a mechanism separate from the reports by which users can quantify the sources of risk and return for a given portfolio in a customized fashion. These tools can be accessed, for example, from an Internet or intranet web page, and provide a flexible mechanism to measure, monitor, and study sources of portfolio risk and return. A wide variety of tools can be implemented and provided for use in an interactive and on-demand basis.

### BRIEF DESCRIPTION OF THE FIGURES

The foregoing and other features of the present invention will be more readily apparent from the following detailed description and drawings of illustrative embodiments of the invention in which:

FIG. 1 is a general flow and structural diagram of a system implementing the present invention;

FIG. 2 is an illustration of system architecture showing details of a data warehouse

FIG. 3 is a high-level diagram of one implementation of the data integrity system;

FIG. 4 is a sample computer input screen providing user access to diagnostic reports;

FIGS. 5-8 are illustrative diagnostic reports generated by the data integrity system illustrating the imbedded links to detailed reports and a data update interface;

FIG. 9 is a screen shot of a user interface menu that provides access to financial data for export from the system;

FIG. 10 is a high-level flow of an implementation of factors and risk-return calculations performed by the analyitics system;

FIG. 11 is an illustration of the relationship between factor, model, and portfolio definition tables and objects;

FIG. 12 is a sample model definition template;

FIG. 13 is a sample portfolio object definition;

FIG. 14 is a high-level flow chart showing the general operation of the analyitics system;

FIG. 15 is a screen display showing a sample home page for accessing reports, tools, and other data from the reporting system; and

FIG. 16 is a partial hierarchical diagram of the various sub-pages and functions accessible from a particular implementation of the page of FIG. 15.

### DETAILED DESCRIPTION OF THE PREFERRED EMBODIMENTS:

The present invention is discussed herein with reference to a financial data and portfolio analysis system. However, the invention is also suitable for use in other data warehousing and analysis systems and should not be considered as being limited to use only in the environments of the preferred embodiments.

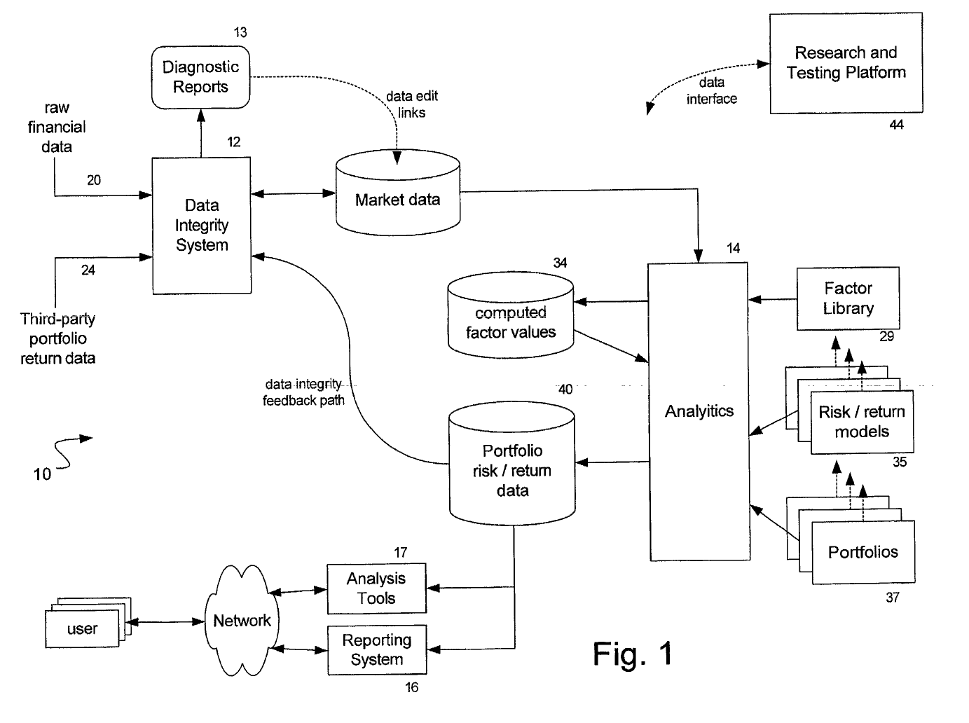

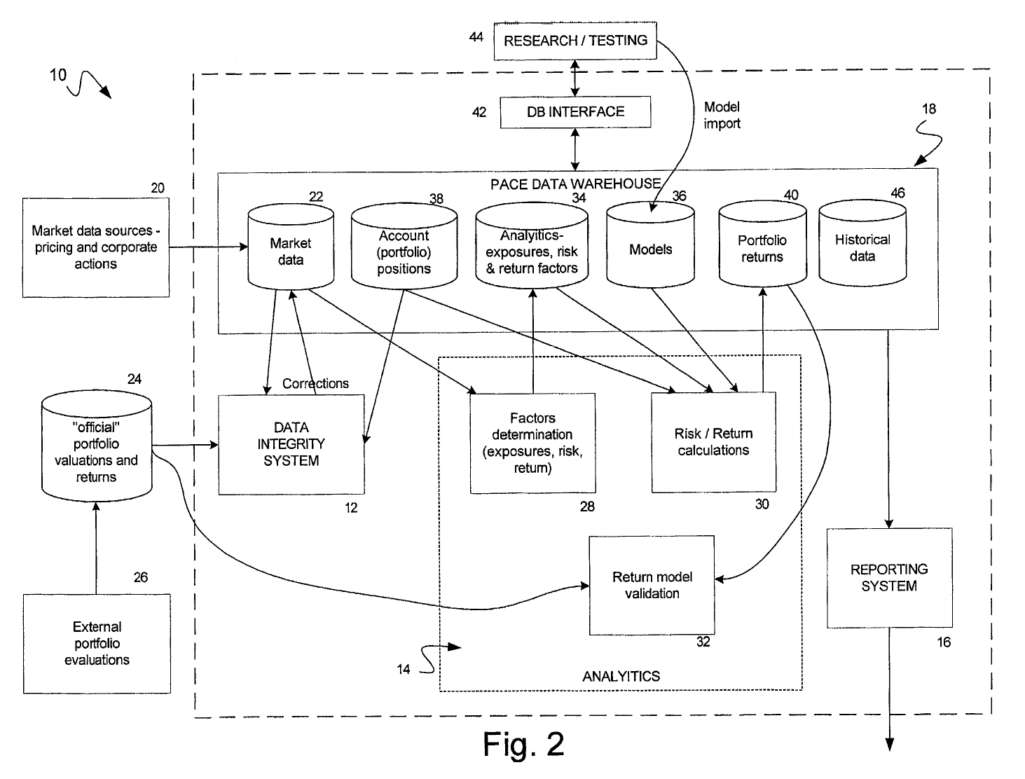

Turning to FIGS. 1 and 2, there is shown system-level diagrams of a preferred implementation of the PACE system. In this embodiment, PACE is comprised of a data integrity system 12, an analyitics system 14, and a reporting system 16. A set of analysis tools 17 separate from the reporting system 16 can be provided or the tools can be considered a component of reporting. Each of the various systems accesses data stored in one or more databases which together are referred to herein as a data warehouse 18.

Data warehouse 18 can include one or more independent database systems and is used to store market data, model definitions, determined risk and other factor values, and historical data. In addition, data specifying the various account positions for the given portfolios and other data can be stored in the data warehouse 18 or, if stored in another system, mirrored in whole or part for ease of access. In the discussion herein, various types of data will be considered as being stored in separate databases in the data warehouse 18. However, the division between databases is not a rigorous one and, so long as the appropriate data can be stored and retrieved, the particular manner of database implementation is not critical to the invention. In a preferred embodiment, the data warehouse 18 is divided into the various databases shown in FIG. 2. A Frame database is used to store historical data and a Sybase® database is used to store current data, including model and market data, output from the analyitics system 14, portfolio positions, and portfolio returns.

Market data and other source of raw information is received from data sources 20 and stored in a market data database 22. Various data sources can be used, such as Bloomberg, Extel, and Muller.

The data integrity system 12 processes to ensure its accuracy prior to the data being used by other system elements. Various data checks can be implemented. In general, however, security price information is compared to historical data to detect any outliers or other unusual values which could indicate that the received data is in error. Diagnostic reports 13 are generated which highlight unusual values. As discussed more fully below, the reports 13 preferably contain links to a data entry module connected to the data warehouse such that when an incorrect data point is identified, a user can correct the underlying data directly through a diagnostic report by selecting the incorrect data point and activating the data edit link. Additional links can be provided to allow an operator to easily access detailed reports underlying summary data and local and remote information about corporate actions and other data to aid in the determination of whether outlier data is accurate.

Additional verification of data integrity is provided by comparing “official” portfolio valuation and return data 24 provided by a source 26 external to system 10 with account valuation estimates generated by the analyitics system 14 using data from the data warehouse 18. A return model validation module 32 can be provided to perform this function. Because the model validation module 32 is closely tied to the analyitics system 14, it can be considered to be part of the analyitics system 14 (such as shown in FIG. 2), part of the data integrity system 12, or a stand-alone element.

The data integrity feedback path between the data integrity system 12 and the analyitics system 14 provides validation of the models and model factors being used by the analyitics system 14. It also aid in the detection of systemic errors which may not otherwise produce specific data outliers. In particular, substantial discrepancies could indicate problems in the received market data, errors in the portfolio definitions or performance models, or even errors in the “official” valuations. These discrepancies are preferably flagged or otherwise identified so that follow-up actions can be taken if needed. Advantageously, because the system uses valuations of actual client portfolios in the data integrity process, as opposed to limiting the integrity check to comparisons with standard benchmarks, such as provided by Standard & Poors, further assurances are provided that data related to securities which are not part of standard indices, but which are important since they are present in client portfolios, is accurate.

The analyitics system 14 contains the modules which process and analyze current and historical financial data to generate appropriate factors and applies these factors to financial models to calculate risk, return, or other values for portfolios of interest. In a particular implementation, the analyitics system 14 includes a factors determination module 28 which processes the market data 22 to determine or estimate values for the various exposures and other market-derived factors which are needed for subsequent processing. The particular factors which are available can be specified in a factor library 29 and the computed values can be stored in a factors database 34. (It should be noted that while factor library 29 is discussed herein as a unified entity, the factor definitions may be distributed in various software modules or routines in the analyitics system.)

One or more models 35 to evaluate various attributes are stored in a model database 36. The models, regardless of whether they are geared towards evaluating risk, return, or other values for a given portfolio, are constructed to be dependent upon one or more of the factors in the factor library 29.

Specifications for client portfolios or other portfolios of interest 37 are stored in a portfolio position database 38. Each portfolio which is to be analyzed is associated with one or more models 35 in the model database 35. As will be recognized by those of skill in the art, the investment strategy underlying a portfolio can have an impact on which types of analysis should be done and the type of model which should be applied. Advantageously, this feature allows an authorized user to associate the most appropriate models with each portfolio.

On a daily basis, or as otherwise specified, a risk and return module 30 in the analyitics system 14 applies the market data 22, determined factors 34, and the models 36 associated with the particular portfolios (as specified, e.g., in the account position database 38) to the portfolios to generate risk, return, and other modeled data. The generated data is then stored in a suitable portfolio risk/return database 40.

The reporting system 16 utilizes data from the data warehouse 18, including the modeled portfolio attribute data generated by the analyitics system 14, to generate series of reports for the various portfolios. These reports can be made available to users via a web-link through a network, such as the Internet. Analysis tools 17 can also be provided as part of or in addition to the reporting system 16. Preferably, these tools can be accessed by clients through the network and provide a flexile mechanism to measure, monitor, and study sources of portfolio risk and return in an interactive and on-demand basis. A preferred set of tools comprises risk decomposition, return attribution, variance analysis, exposure attribution, historical simulation, a stock and industry concentration locator, and a company watch tool which is used to monitor the financial strength of companies to provide data which can be used to identify forms portfolio managers may want to exclude from various portfolios.

Finally, a database interface module 42 can be provided to allow data to be exported from the data warehouse into a testing environment 44, such as a MATLAB® environment. The exported data is formatted in a manner which facilitates analysis and model development outside of any restrictions present within the system 10. Because the research environment directly accesses the validated data used by the rest of the system 10, analyses performed in the testing environment can be compared with output from pre-existing models. In addition, direct access allows new models to be developed based upon the factor library 29, greatly simplifying the development and testing of models and subsequent importation of models into the system 10.

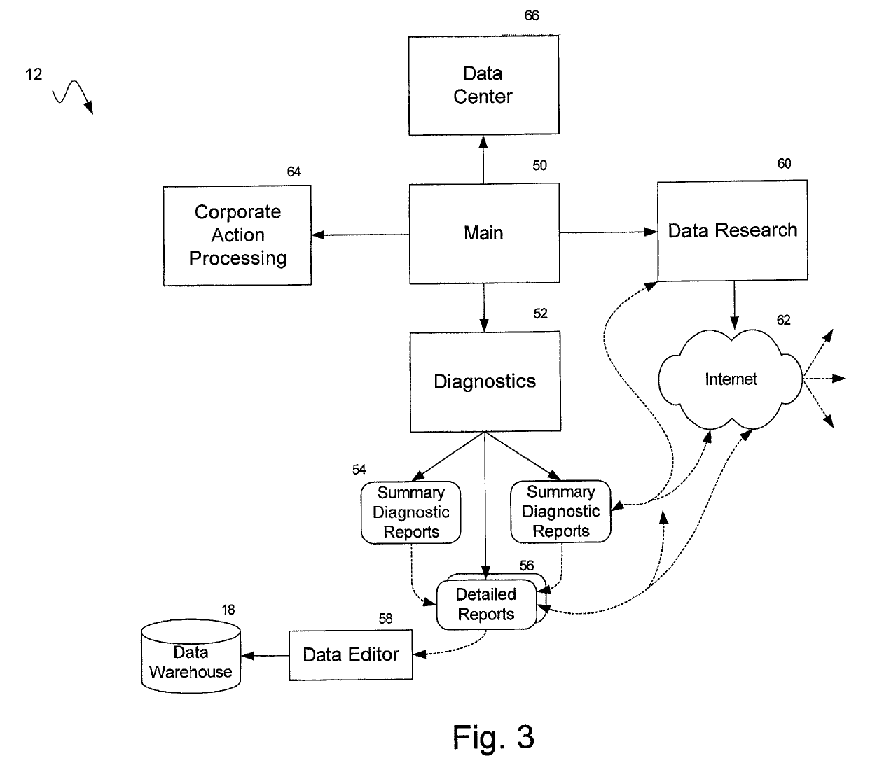

A key element to providing a quality portfolio management and analysis system is data integrity. Turning to FIG. 3, there is shown a high-level diagram of the major elements of a preferred implementation of the data integrity system 12. Links to data sources external to the overall system 10 have been omitted for clarity. The specific organization of the various functional elements shown in FIG. 3. Not all elements need be provided in any particular implementation and variations can be made without departing from the general nature of the invention.

Diagnostics model 52 is configured to generate diagnostic data reports 54, 56 which highlight potential data problems. A communications network, such as an internal intranet or a secure Internet connection, can be used to facilitate the distribution of data integrity reports to users in various locations who are responsible for ensuring data integrity. The reports are preferably in HTML format and at least summary reports 54 contain links to more detailed reports 56 to permit a user to “drill down” into the report and view the source data used to generate the summary. Data which maps to data points in the data warehouse can have data edit links to a data editor 58 which is connected to the data warehouse 18. A user selecting such a data edit link from a diagnostics report will be presented with a data editing screen from which the underlying data can be directly modified.

By allowing an operator to correct erroneous data directly from a diagnostic report, correction of such data can be done rapidly and easily. To aid in identifying data errors, the reports can also contain links to internal and external data sources to allow a user to access information about various companies and other financial data which may be relevant to determining the accuracy of a given data point. In a particular configuration, a data research module 60 is provided and serves as a gateway to access such information. Other links can be provided to data sources through appropriate intranet and Internet connections 62.

For example, in a particular embodiment the diagnostics system 12 can generate on a daily basis an outlier report to trap missing and inaccurate data, a corporate actions report, and a “W prime R” report which compares estimated returns on portfolios (as generated, e.g., by the analyitics system 14) with their official, reported number. These reports are distributed via a data network and can be monitored by users in various offices. When an incorrect data point is identified, the user accesses the data editor 58 by selecting the data edit link underlying that data point and inputs the changes directly into the data entry form. The corrected data is then used to update the value of the data point in the data warehouse 18. In addition to updating the database, notifications about data corrections can be automatically distributed to various users of the system as desired. Appropriate security controls can be implemented to limit the types of data which various users can correct and mechanisms can be provided to allow corrections to be easily undone if necessary. Tools and methodology to implement these features will be known to those of skill in the art.

In addition to generating reports which check raw data, preferably a corporate action processing module 64 is provided to process data related to corporate actions which can effect subsequent processing and update internal securities tables accordingly. A corporate action, as used in this context, refers to a change in a company's status or equity distribution policy. Examples include a change in a CUSIP or SEDOL identifier, an acquisition or merger, a stock split and a cash dividend. Corporate actions, such as splits, name changes, and dividends, can affect how stock prices and other financial data must be processed by the system 10.

The corporate action processing module 64 receives data input from one or more corporate information vendors, such as Muller and Bloomberg. The data can be fed directly to the corporate module 64 or stored as appropriate in the data warehouse 18 or another storage facility which is accessible to the module 64. The data files are processed to extract information about various corporate actions and this information is used to update appropriate reference tables containing data related to information about the various securities and which are used when evaluating a portfolio.

The corporate action data is generally well defined and supplied in a predefined format. Preferably, an automated system is provided to process the corporate input data to extract these corporate actions and update the appropriate internal data. In a particular embodiment, the following types of corporate actions are automatically processed: IPOs, Ticker changes, Name changes, CUSIP changes, Exchange listing changes, Stock splits, and Cash/stock dividends. Changes to a name, a ticker symbol, or a CUSIP number are processed by updating data entries in an appropriate security table to permit old and new references to the security to be processed appropriately. Stock split data is used to determine whether a change in a number of outstanding shares is correct, whether a split date supplied by a data provider is correct, and to generally ensure that the stock split is correctly represented. Various techniques known to those of skill in the art can be used to represent the stock split in order to correctly process historical data. Similarly, cash and stock dividends affect and are incorporated into the calculation of a security's total return. The manner in which these actions are extracted is dependent on how the data is coded in the input data steam. Various techniques for extracting this data and automatically updating dependent internal reference data will be known to those of skill in the art. In a preferred implementation, the data processing routines are implemented using per1 and, in addition to updating internal tables, the processed data stored in one or more text files which can be reviewed by an operator as desired. Other techniques are also possible.

Certain corporate actions, such as delistings, spinoffs, mergers, and acquisitions are preferably processed manually. Upon the occurrence of such an event, the accuracy of the event can be verified by a research team using internal and external data sources accessed via the data research module 60 or by other means. Similarly, corporate actions that cannot be processed automatically, such as when a security is unrecognized, can be reviewed manually. Preferably, the CUSIP identifier for a security is used to access an on-line data provider, such as Bloomberg or YAHOO Finance, to obtain current news releases and corporate action summaries which might explain any acquisition activity, name changes, mergers and acquisitions, etc., for a given security. This information can then be used by an operator to determine if the data provided to the system is accurate.

Some actions can be processed on an ad-hoc basis. For example, on a monthly basis, additional reference data can be received, e.g., from CRSP and Barra, related to new securities. When this data is received, the vendor's reference data can be added to the data warehouse 18. Those securities in the vendor data set but not already defined in the system can be selected and a determination made regarding whether the selected securities are new issues or the result of changes to a security's CUSIP. This can be done by cross-referencing another identifier for the security (such as permnos for CRSP and barraids for Barra). A data file can then be prepared which contains both new issues and CUSIP changes and this data imported into the system.

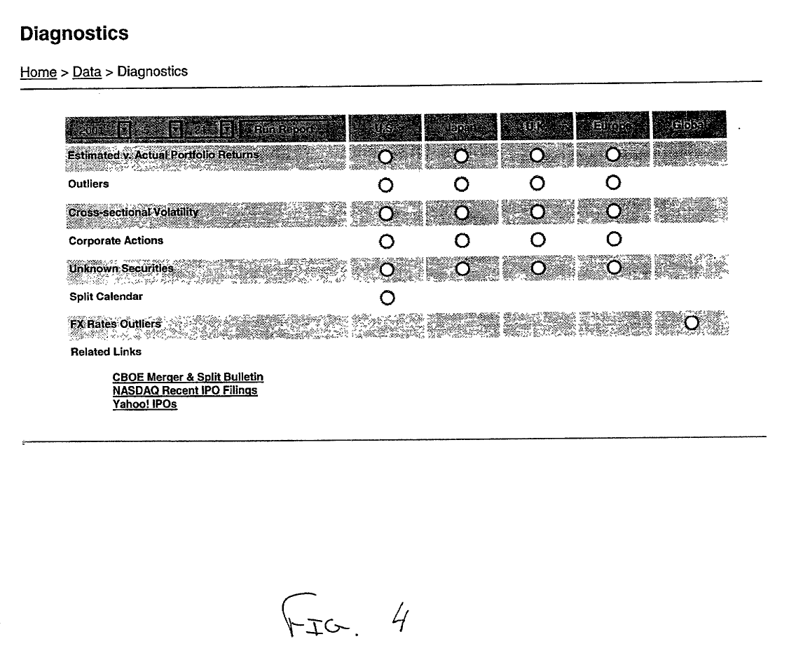

Returning to the diagnostics module 52, in a preferred embodiment, module 52 is accessible via a web-browser interface (not shown) supported by a main module 50 which provides users access to a web page form from which one of a number of predefined data diagnostics reports can be selected for execution against data for specified markets. A sample form is shown in FIG. 4. (Direct access to the diagnostics module 52 can also be provided.)

As illustrated in FIG. 4, there are a number of different types of reports 54 which can be accessed and which can provide indicators useful in detecting unusual data trends that could signify errors in the incoming data. The user is preferably permitted to specify the date of the data to process for the reports. If the report has been previously generated, that report can be provided. If the user selects a report which has not yet been run, a report generation process can be executed and the new report provided to the user and stored for subsequent access by others.

One diagnostic report of particular value is a report comparing estimated portfolio returns as generated, e.g., by the analyitics system 14, with vs. “actual” returns provided by a source external to system 10. Portfolio returns can be estimated by using account information which specifies the instruments in the portfolio, the quantity of each instrument in the portfolio, and the pricing information. The calculated portfolio return data is compared with an “officially” provided value. The report can be run against both actual client portfolio data as well as benchmark portfolios. The results presented in the report can then be filtered, if desired, so that only portfolios comparisons having a discrepancy greater than a predefined value are indicated and sorted so that portfolios having the largest discrepancies are listed first.

It should be noted that in practice, official portfolio valuation data is preferably based upon actual trading data for the portfolio at issue. Since multiple trades can be made against a portfolio in the course of a given day, the officially derived portfolio valuation can be different from a valuation which considers only the final portfolio contents at the end of the trading day and the closing price for the relevant securities.

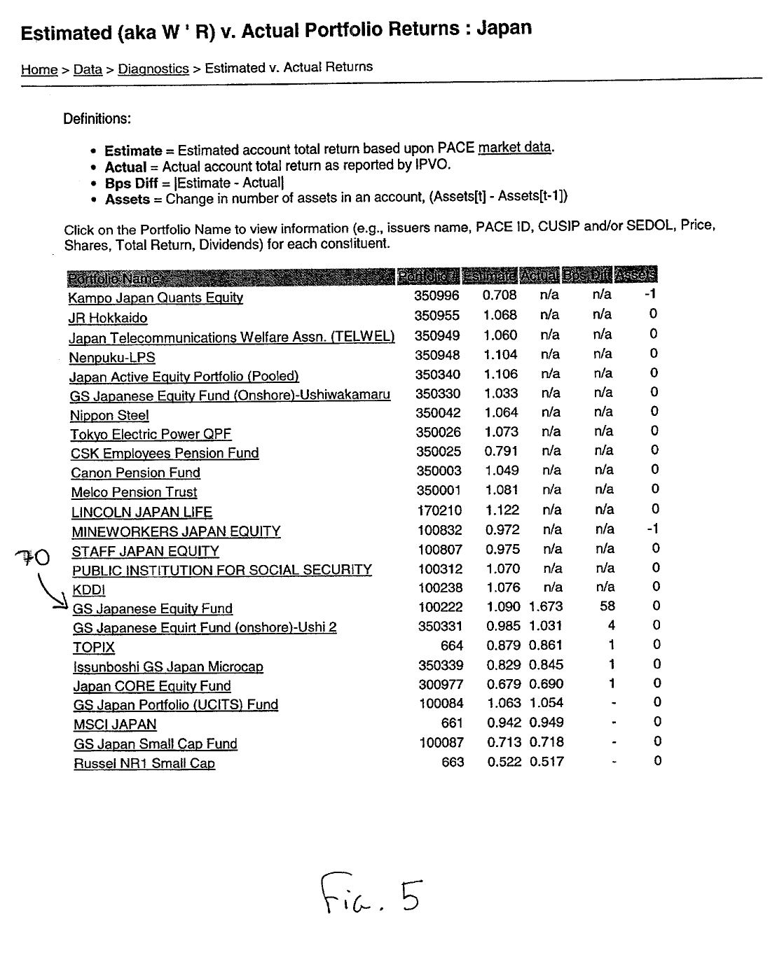

An example Estimated vs. Actual Returns diagnostic report is illustrated in FIG. 5. The report can be formatted in various ways. Preferably, portfolios are identified by both name and account number, the actual and estimated returns are shown as percentages, and the difference indicated in terms of basis points. A large basis point difference between the official and estimated return indicates that there may be data issues which should be investigated further. In the example report shown in FIG. 5, and with reference to line 70, the estimated value of the “GS Japanese Equity Fund” differs from the official value by 58 basis points (as compared to only 4 basis points for the next highest entry.) This large relative differential between the estimated and actual portfolio valuation indicates that there may be a data or other error and that further investigation is warranted.

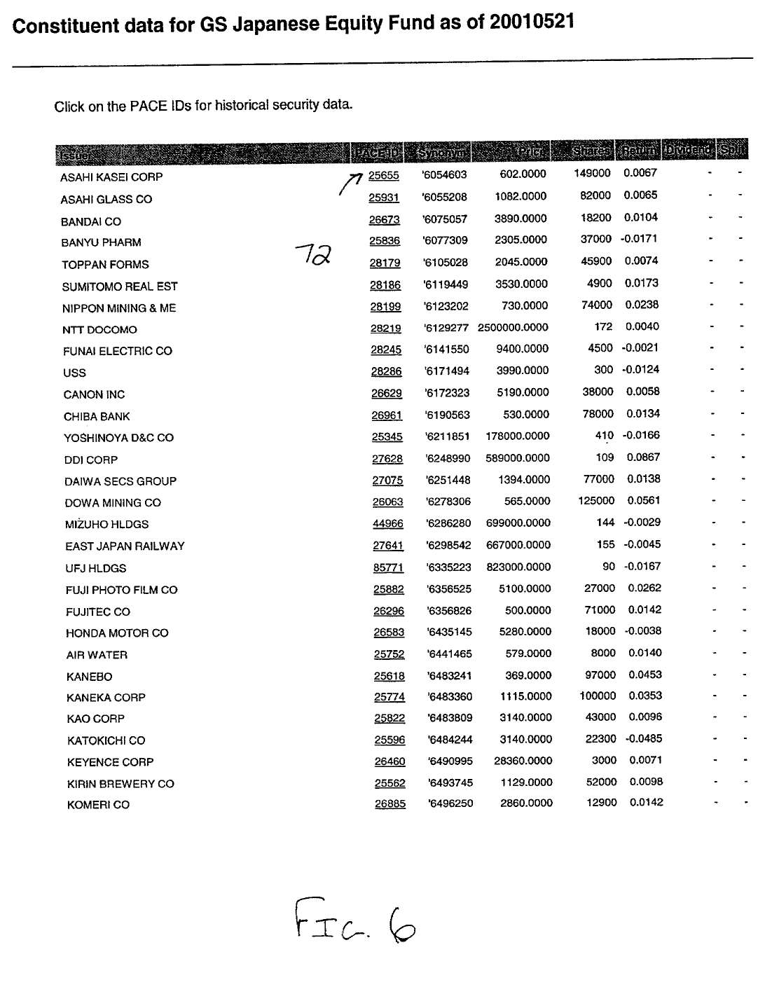

Preferably, each portfolio listed in the report has an underlying link to a more detailed sub-report which lists the portfolio contents and the data used to derive the estimated value. Selecting this link for a given portfolio will automatically access the relevant report. FIG. 6 is a portion of a sample report of the constituent data for the GS Japanese Equity fund. In the preferred configuration, this report lists the issuer or security as well as its current price (here in 1 h Yen), the number of shares, and the calculated return for that security. Additional data, such as dividend and splits, can also be shown. To permit more detailed analysis, a further hyperlink for each security, here positioned under the security ID, can be provided. Preferably, when this link is selected, a historical time-series report for the selected security is retrieved or generated (using the historical data in the data warehouse) to allow an operator to better determine whether a present value is consistent with prior actions. For example, selecting link 72 for the Asahi Kasei Corp. will preferably access a time series data report for that security. More sophisticated tools to further analyze the historical data, graphically display it, or perform other manipulations can also be provided.

Another type of diagnostic report that can be provided is an outlier report. In general, outliers are securities in which the current price is not consistent with prior values, is missing, or is otherwise suspect. Preferably, the outlier diagnostic is run against all unique securities that are held in separate accounts or mutual funds as well as all securities which are contained in a major market benchmark. Outliers can be identified and sorted according to type. Each outlier can be provided with one or more links which allow access to underlying or related data, such as a time series report. As discussed above, the underlying report can contain data edit links for each data point which, when selected, automatically launches the data editor 58 to allow the value of the selected data point to be corrected as appropriate. A separate link can be provided to access the data research module 60 or directly link to an external data source to gain access to news and information which would aid a user in determining whether an explanation for suspect data is present.

Various attributes or characteristics can be used to trigger an outlier designation and the grounds for assigning outlier status to a security can be identified in the report. In a most preferred embodiment, a security having one or more of the following characteristics can be considered an outlier:

price is the same as the previous day's data observation

price or trading volume is missing

price and/or trading volume is zero trading volume has exceeded 5 times the 5 day average trading volume for that entity

trading volume is less than 20% of the 5 day average trading volume for that entity

unadjusted shares outstanding (USO) has exceeded 5 times the 5 day average USO for that entity

unadjusted shares outstanding (USO) is less than 20% of the 5 day average USO for that entity

unadjusted shares outstanding=zero

total return is greater than the market benchmark return +30%

total return is less than the market benchmark return−30%

total return is <=−0.75 or >=0.75

identifier (e.g., CUSIP or SEDOL) cannot be found in system's product table

market cap of a security divided by the total market cap of all stocks in the relevant market >10%

In different embodiments, additional outlier definitions can be used and others omitted. The values used to define an outlier can be selected as desired in order to balance the number of false positives, the time required to investigate outliers, as well as the desire to provide accurate data. Because of differences in factors such as market volatility, changes considered unusual or W suspect on one market may be typical in another. Accordingly, different sets of outlier rules can be defined for use with particular types of securities or as otherwise appropriate.

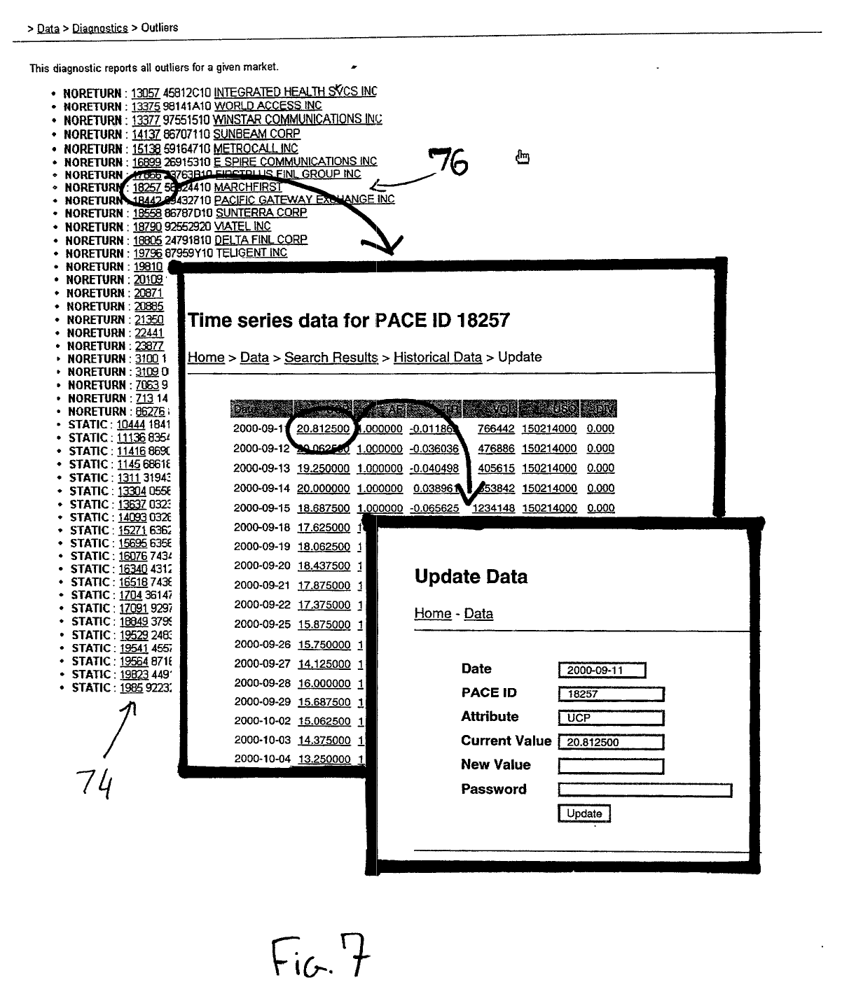

A portion of a sample outlier report for U.S. securities is shown in FIG. 7. Each identified security has a first link 74 (under the reference ID number) which provides access to an underlying time-series report and a second link 76 (under the security name) which can provide access to research information. A time-series report which could be generated in response to the selection of link 74 for the “Marchfirst” security is shown. A sample data update which can be presented upon selection of a data edit link point in the time-series report is also shown.

Several other diagnostic reports can also be generated. For example, a total cross-sectional volatility report for a particular market based upon, e.g., the standard deviation for the set of 1-day returns for each stock in a market for a particular day, can be provided. Usually, standard deviations are calculated using temporal data for a single security. The cross-sectional volatility typically highlights severe price levels. The report can be sorted by date and indicate both the cross-sectional volatility as well as the number of securities which were considered. Days with unusual volatility values or numbers of securities can indicate potential data problems or other market conditions which may be of concern or should be noted when considering the accuracy of other data.

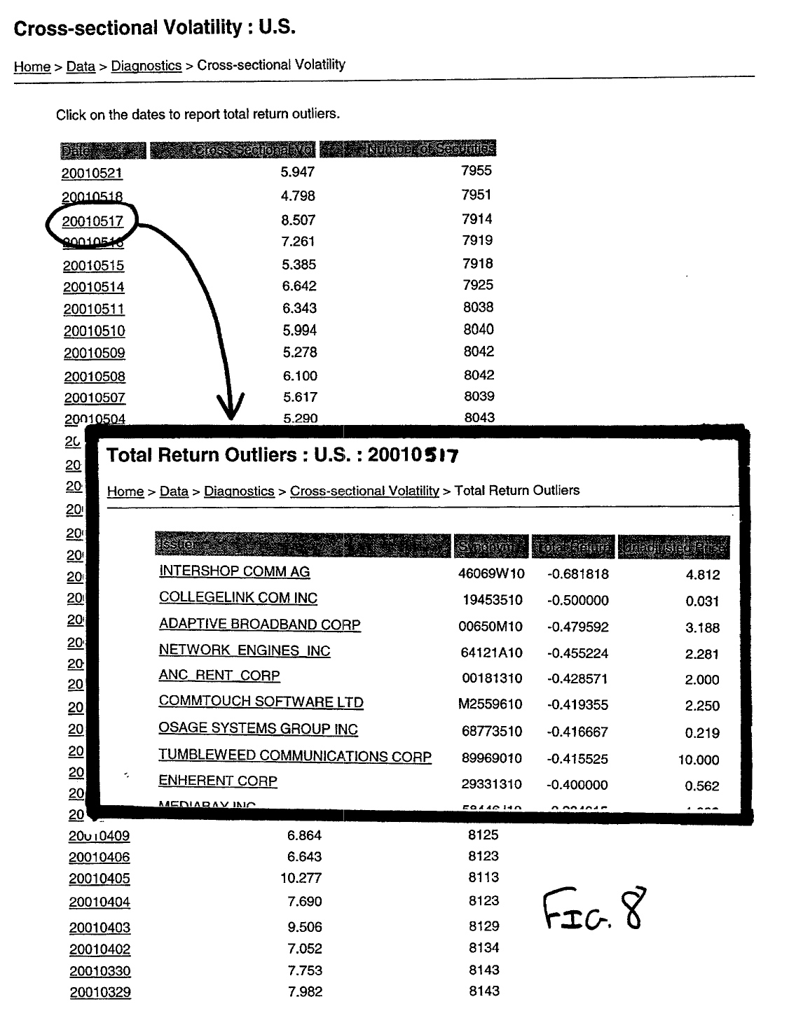

As in other diagnostic reports, links to underlying data reports can be provided. Preferably, each date entry in the cross-sectional volatility report contains a link to a report which indicates the outlier securities relative to total returns. Unlike reports based upon the contents of a particular portfolio, the total return outliers report can be based upon an analysis of all returns in a specified equity market and contain entries for each stock where the total returns are greater than a specified value, such as 50 basis points. A portion of a sample cross-sectional volatility report and linked total return outlier report is shown in FIG. 8. The issuer of outlying securities can be linked to yet a further sub-report, such as a time series which lists closing prices, adjustment factors, total returns, volumes, shares outstanding, and dividends from which the data editor can be accessed (not shown).

Other diagnostic reports can also be provided, such as a report summarizing corporate actions, listing unknown securities, outliers in foreign exchange rates, and a calendar of when stock splits have and are scheduled to occur. Preferably, these additional diagnostic reports also contain linked data fields which permit direct access to one or more related reports explaining underlying data, to external research and news gathering tools, and to the data editor as appropriate to the specific reports and data at issue.

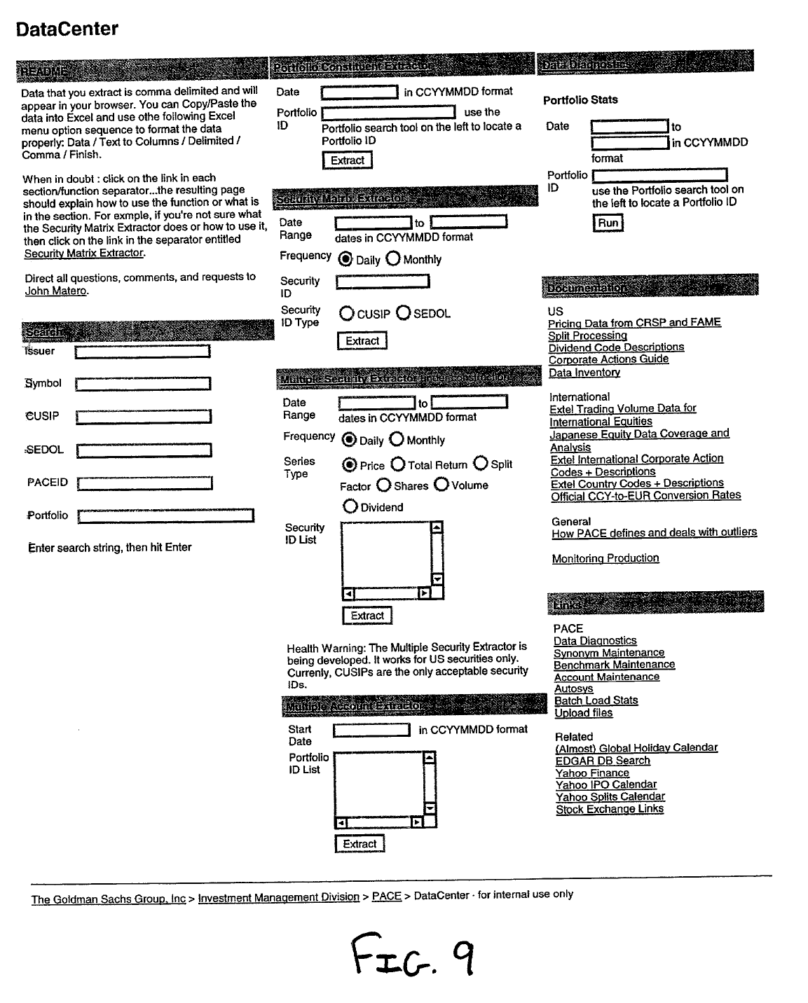

With reference to FIG. 3, the data integrity system 12 can further comprise a data center module 66 which is configured to provide centralized menu from which data can be extracted from the data warehouse 18 or diagnostic reports or one or more specified securities or portfolios on given dates can be accessed. Preferably, a user is given the option to receive data in a format which is configured to simplify data imports into spreadsheet or other data visualization software, such as Microsoft Excel. A particular implementation of the data center interface menu is illustrated in FIG. 9.

As will be appreciated, the various reports generated by the data integrity system 12 can be generated on a periodic basis or on-demand. Preferably, as reports are generated, they are stored in the a suitable manner to permit access as needed and/or distribution to a distributed user base. In a particular embodiment, at least a portion of the diagnostics system is configured as a web-server which can be accessed, e.g., through the diagnostic report interface shown in FIG. 4 or the data center interface menu shown in FIG. 9.

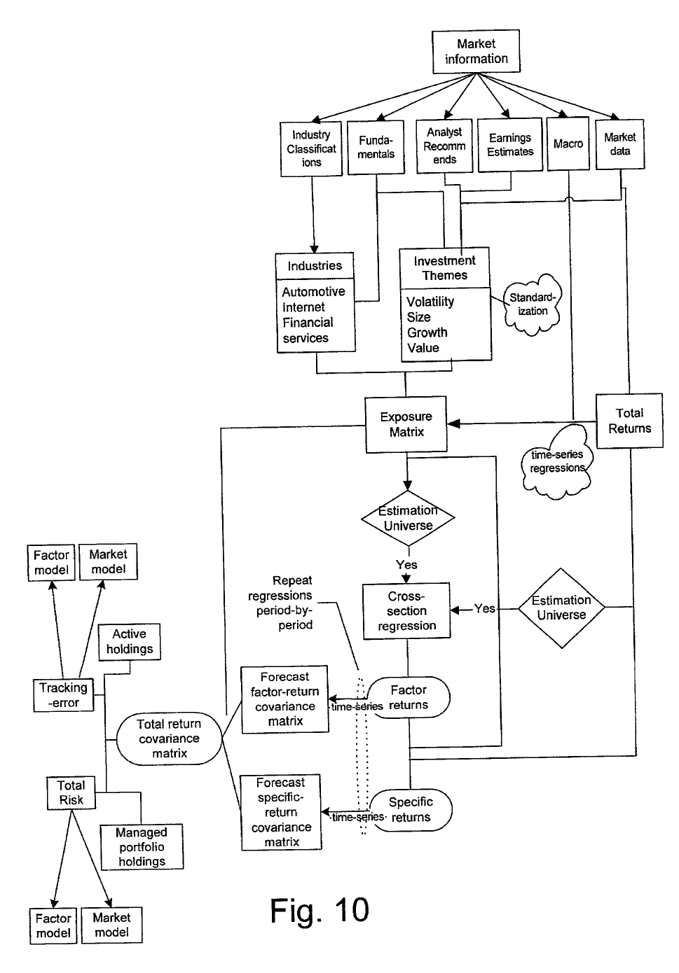

After the integrity of the source financial data has been verified, or the data is otherwise approved for at least limited use, the analyitics system 14 can operate on the data. The analyitics system 14 is broadly implemented along conventional techniques for generating exposures and risk factors from underlying financial data, performing regression analysis to generate appropriate covariance matrices, and then applying the data to determine risk and tracking errors. A high-level flow of the factors and risk-return calculations is illustrated in FIG. 10. Such general techniques will be known to those of skill in the art and therefore the mathematical details will not be discussed herein.

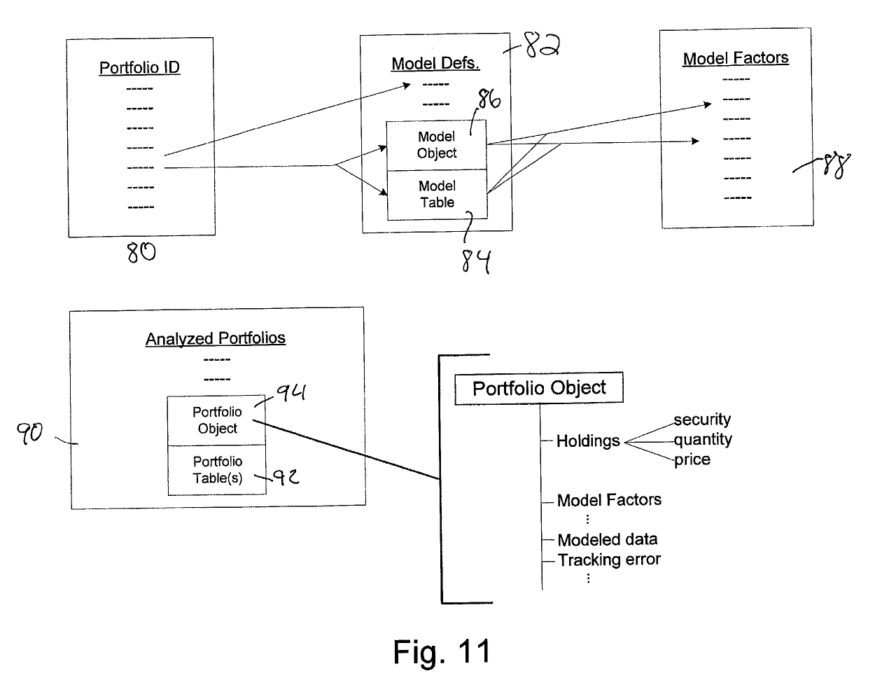

Although the overall analyitics process can be implemented in accordance with conventional methods, various new features which are implemented within the analyitics system 12 add power and flexibility to the PACE system that are not present in conventional systems. With reference to FIG. 11, and according to one aspect of the invention, various data processing tables and storage areas are provided for use during analyitics processing.

A portfolio ID table 80 is provided which contains at least a list of the portfolios defined in the system along with links to the specified models to be executed against the portfolio. The links can preferably be specified and adjusted as desired by system users having appropriate authority. The various tables can be implemented separate from or in conjunction with the account positions database 38 shown in FIG. 2. It should be noted that while table organization of this data is preferred, the data can be stored in alternative manners. For example, rather than providing a table associating each portfolio with one or more models, the association data can be distributed and stored, e.g., as an attribute of each portfolio definition.

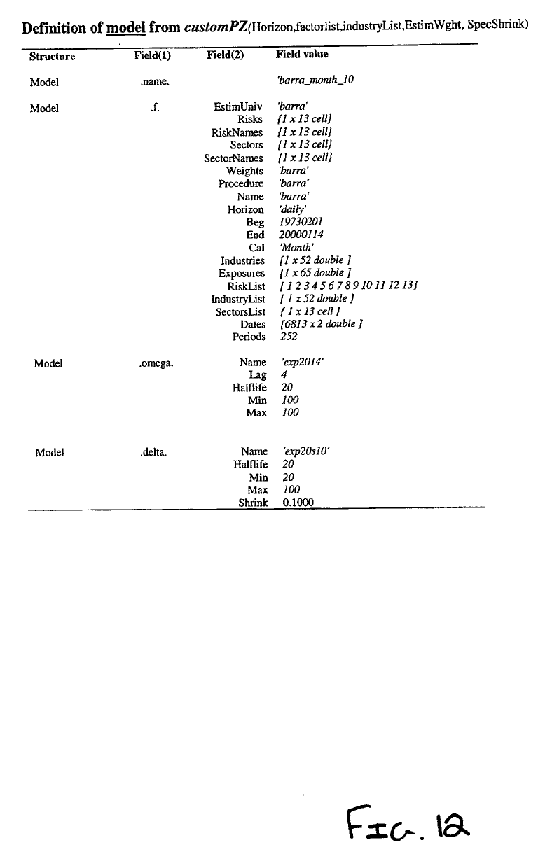

The specification for the models, such as models for characterizing risk, return, or other attributes, are stored in one or more model definition tables 82. Models can be specified in several ways. In a preferred embodiment, models are specified as a model “table” which contains a model definition in a form suitable for processing by the system illustrated in FIG. 10. In addition, models are specified as model objects 86 which are configured to be compatible with a designated testing environment. In a preferred implementation, a MATLAB® testing environment is provided and the model objects 86 are configured so that the object can be easily loaded, via the database interface 42, directly into the MATLAB® environment using a single command or at least with minimal effort. A sample model object specification is shown in FIG. 12.

The library of available factors which are evaluated by the analyitics system can be specified in a model factors table 88. Each model is linked to the specific factors which are required to use that model. Various methods of implementing such a linkage can be used. By combining data from tables 80, 84, and 88, a determination can quickly be made regarding which models are to be used for a given portfolio, which factors are needed in order to use particular models, and, for example, which factors must be evaluated in order to evaluate every model associated with portfolios in a given portfolio set.

During the portfolio analysis, the appropriate models are executed against a given portfolio. The underlying and determined portfolio data is preferably stored in a portfolio object 94. In particular, when processing starts, an unpopulated portfolio object 94 is generated which contains object fields defining the contents of the portfolio (e.g., the type and quantity of the holdings and the prices on the date at issue), the factors which are required by the models associated with the portfolio, as well as fields for other data generated during the analyitics process, such as tracking error.

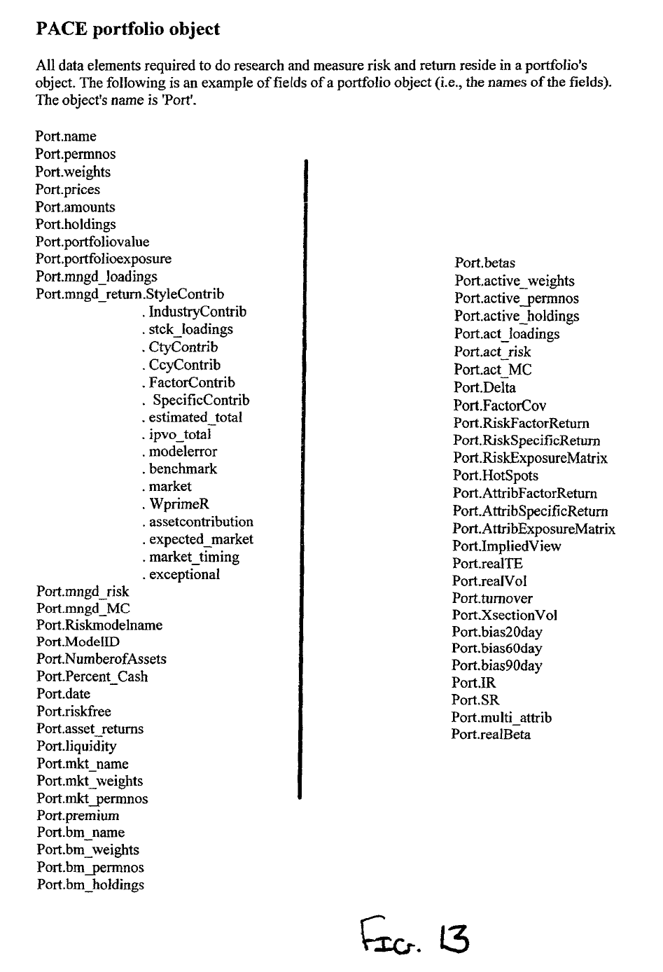

The structure of the generated portfolio object 90 can be evaluated to determine which information is needed to process the portfolio. This information is then obtained or derived as needed and the portfolio object is populated on-the-fly. After the process is complete, the portfolio object is stored. The portfolio object 94 is preferably formatted to be compatible with the designated testing environment and, similar to the model objects, can be loaded into the testing environment using a single or small number of commands. A sample of a particular portfolio object definition is shown in FIG. 13. In this object, a set of data fields considered as necessary to do research and measure risk and return in a particular implementation are defined for a portfolio object having a name “Port.”

Advantageously, this methodology permits a large amount of information relative to the portfolio to be easily exported to the testing environment where further analysis can be performed. In addition to storing the populated portfolio object in a manner accessible to the testing environment, the contents of the portfolio object can also stored in a second format which for simplifying access to the data by a reporting systems. For example, a portfolio table 92 containing data similar to that in the portfolio object but configured as tabular data can be stored in a conventional relational database in the data warehouse 18.

Although various separate tables have been illustrated in FIG. 11, information can be stored in different arrangements using more or fewer tables or even non-table based storage environments. Implementations which preserve the basic functionality illustrated in FIG. 11 and discussed above will be known to those of skill in the art and the particular manner of implementation.

In the preferred implementation, the analyitics environment is built around the risk model object and the portfolio object. Each object can be initialized or constructed using constructors and modified using methods. The risk model object defines the risk model that will be used to estimate risk and measure performance attribution. The portfolio object defines characteristics of a portfolio (relative to measuring its risk and return). In a preferred embodiment, a performance object is also provided. This object is similar to a portfolio object except that it is used to store time series information whereas the portfolio object's information is only as of a particular point in time. Because of this similarities between the performance and the portfolio objects, the performance object is not addressed separately in detail herein.

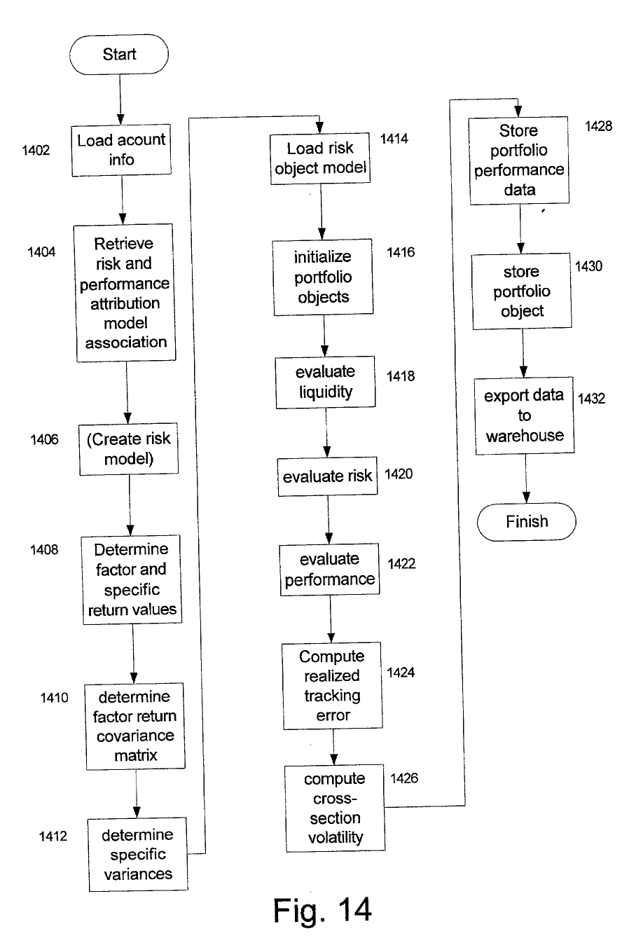

A more detailed diagram of the preferred analyitics system flow is illustrated in FIG. 14. The particular portfolio calculations and the associated mathematics can vary and such details are not relevant to the present invention. As a result, the various calculation steps are discussed only generally. Particular methods and procedures to determine the referenced values are known to those of skill in the art.

Turning to FIG. 14, when a production is initialized, the information for the specified account is accessed and information related to the associated risk and performance attribution model(s) is accessed. (1402, 1404). This information generally indicates which models are to be run against the specified portfolio.

Next, a risk model is created if needed. (1406) The risk model is preferably generated by calling a MATLAB function to generate a new risk model. The inputs to this function are parameters such as the name of the new model, the number of days used to estimate the covariance matrices, the ‘decay’ parameter (i.e., the parameter that determines how to weigh the data when estimating volatility and correlation), and other parameters needed to evaluate a portfolio. The output is a risk model object. This object can be saved as a “mat” file and is loaded when the appropriate reference number is called by the system.

After the risk model is created, an estimate risk model production process is started. During this process the various factors are loaded and determined (1408), followed by a calculation of the covariance matrix (1410) and estimates of specific variances (1412). After this process is complete, the system is ready to apply the appropriate models to the portfolio.

A risk model is loaded into the base workspace. (1414) This model can then be used to estimate risk. Next, the portfolio objects are initialized. (1416) As noted above, unpopulated portfolio objects (as well as benchmark portfolio objects) can be created. Analytic steps are then performed against the portfolio using the appropriate models. Liquidity is measured using a default or specific liquidity model associated with the portfolio. (1418) Similarly, default or specified models for risk and performance attributes, realized tracking error, and cross-sectional volatility are applied and the resulting data stored in the portfolio object. (1420-1426) Additional attributes can also be determined as needed.

The portfolio performance data is loaded in the portfolio and performance objects and the modified objects are stored. (1428-1430). Finally, the portfolio and performance object contents are exported into the data warehouse 18 for subsequent processing by the reports system. (1432) Other relevant time-series data can also be stored in the data warehouse 18.

As discussed above, a database interface module 42 is preferably provided to support data imports and exports from the data warehouse into a research and testing environment 44. (FIG. 2) The preferred testing environment is MATLAB. The interface module 42 is comprised of a series of program elements which can be called from the testing environment to save and retrieve data objects from the data warehouse 18. The specific nature of the interface module is dependant upon the testing environment and the system used to store the data and data objects in the warehouse 18. Various commercial software tool sets are available to facilitate the development of the interface module 42 and techniques for creating a suitable interface will be known to those of skill in the art.

A particular advantage of providing the interface module 42 and in storing models and portfolio information in data objects as well as in a form compatible with the main analyitics system 14 and the reporting system 16 is that actual current and historical data can be exported to the testing environment and used to develop new models or for other purposes. To facilitate new model development, the testing environment can also access not only the model and portfolio objects, but also other data elements in the warehouse 18, including the model factors table 88. As a result, the complete set of factors which are generated by the PACE system are known to the model developer and specific factors can easily be selected and inserted into a model.

Once such a model has been developed, it can be imported back into the system. In one implementation, the new model is assigned a unique ID or other identifier. If necessary, the model object is processed, preferably using an automated tool, to translate the model functionality into a form suitable for processing by the analyitics system 14. The model definition table is updated and links to the model factors used by the new model are established. Once the model has been imported, portfolios can now be linked to the new model as desired. When the analyitics process is next executed, the new model will be recognized by the system and executed against the specified portfolios. Advantageously, the addition of new models can be done easily and without having to update the system code.

In some circumstances, a model will be developed that utilizes factors not included or derivable from the set of available factors If the newly needed factor will have wide usage in the future, it may be appropriate to add this factor to the default factors library (perhaps by modifying the analyitics code). More often, however, such a factor will be used in a customized model having only limited use, e.g., against only one or a few specific portfolios having unique characteristics. Preferably, under these circumstances, values for the new factor are generated externally, perhaps by the model developer or client owning the portfolio, and then imported into the system on a periodic basis, such as with the general financial data. When the model is executed, the custom factor value is retrieved from the data warehouse and used in the model as appropriate.

The third component of the overall PACE system 10 is the report generation system 16. This system acts upon the data generated by the analyitics system 14 and generates a series of high and low level reports which can be used by portfolio managers and developers and other users to track the status of a particular portfolio and compare it with other client portfolios and benchmarks. Unlike conventional systems, the reports are preferably not limited to focusing on a specific portfolio. Instead, reports can be generated which contain high-level summaries of multiple portfolios to permit managers to quickly assess and compare the status and performance of a group of portfolios.

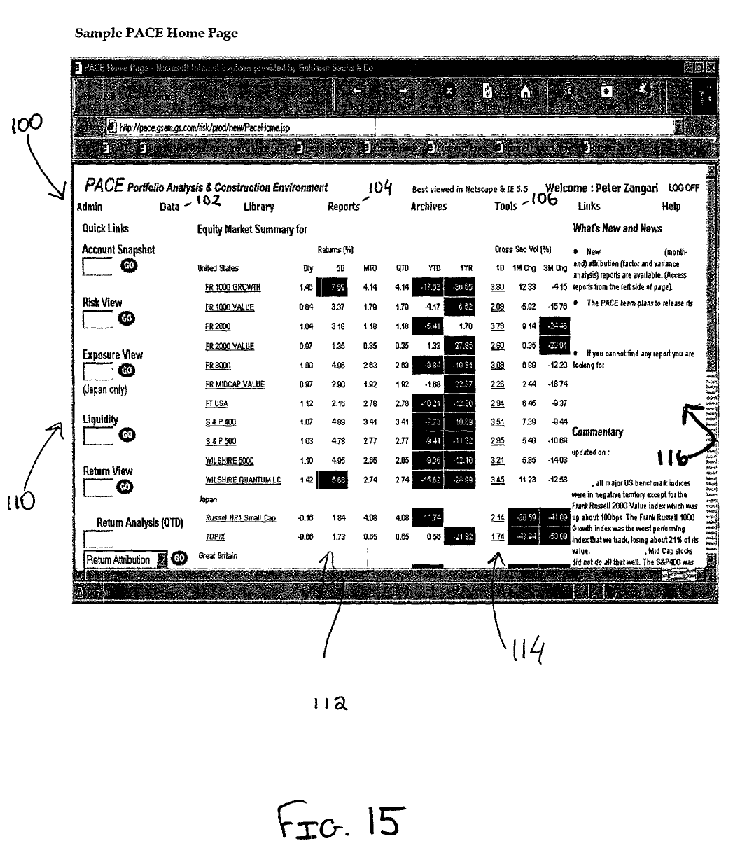

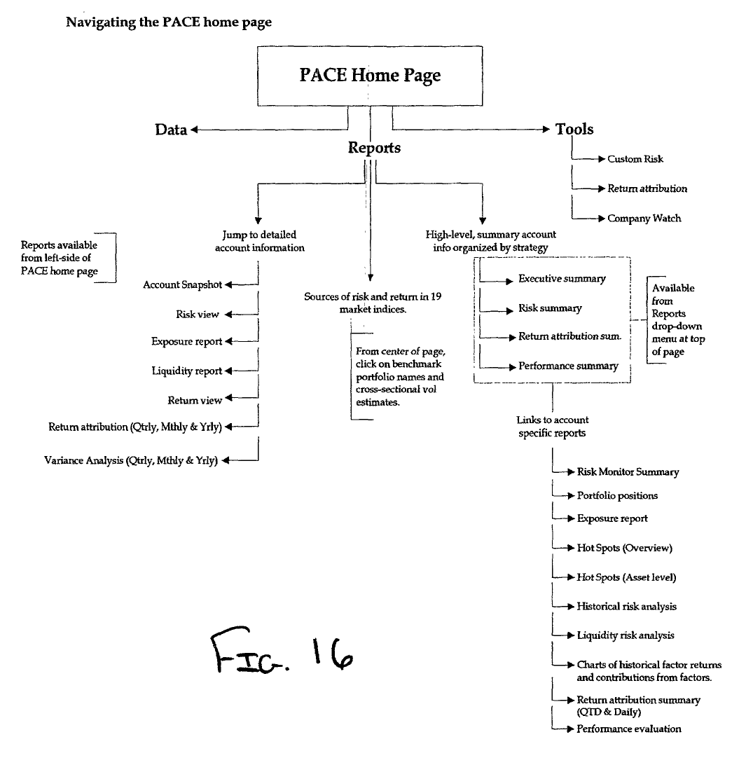

The report generation system 16 is preferably configured to be accessed through a centralized web page which contains links and forms that allow users to quickly access the available reports and other tools and initiate report generation processes as needed. FIG. 15 shows an illustration of a particular implementation of a report generator home page that serves as an entry point to the report generation system and can also provide access to various other data stored in the data warehouse (or elsewhere), tools, or the like. A partial hierarchical diagram of the various sub-pages and functions accessible from the preferred implementation is shown in FIG. 16. The pages can be implemented using conventional Internet development tools and access can be provided via an intranet, the Internet (with suitable additional security features to limit access to authorized users) or other mechanisms known to those of skill in the art. The desired reports can be generated using techniques known to those of skill in the art.

Reports can be updated daily to give portfolio, product, and risk managers access to comprehensive risk and return attribution reports. Various reports can be generated, including liquidity as well as market risk measures. An interactive company watch report can be provided to supply market information on a company's financial strength to aid in credit risk assessments. In addition, tools are available which permit users to run customized versions of risk and return attributions. For example, a customized risk tool can be provided to allow a user to simulate the effect of a change in position of weights on tracking-error. Users are also preferably permitted to execute return attribution reports for any period.

The report product process can be implemented using various aspects of parallel processing. On a daily basis, a number of production jobs can be monitored through a variety of web pages. Because reports should not be executed until the data integrity process is complete, a distributed production environment is preferably used which can leverage the global nature of a large financial institution in order to expand the base of users who can monitor and manage data processing. For example, each day, data quality and computation output can be monitored at offices in London, Tokyo, and New York. By allowing users in London to perform integrity checks and initiate subsequent report generation for U.S. portfolios, accurate and timely data can be provided at the start of the New York business day.

Although the various reports can be made available to all users, computing resources can be conserved by deferring the generation of specific reports until a report's contents are first needed. Because the number of reports which are needed by each facility are generally limited, processing requirements at a centralized central system will be naturally distributed over time. In a more sophisticated environment, the data and functionality can be mirrored at various remotely located systems. As reports are generated, the report data can be distributed to other stations in order to eliminate the need to regenerate the report at multiple sites.

Returning to FIG. 15, the particular implementation of home page 100 provides access to data, reports and tools, as well as risk and return information on major benchmark indices. Near the top of the page 100 are eight links: (1) Admin, (2) Data, (3) Library, (4) Reports, (5) Archives, (6) Tools, (7) Links and (8) Help. Clicking on any of these links activates a menu of available options. For example, from the “Data” link 102, a user can access the data center and, for example, view corporate actions and portfolio holdings or download market data.

The Reports link 104 provides a menu of summary reports that detail high-level risk and return information across a large number of accounts. These reports are useful for determining whether the performance of a particular account or set of accounts is inconsistent with a given investment strategy. Preferably, four summary level reports are provided: (1) Executive Summary, (2) Risk, (3) Return Attribution, and (4) Performance. These reports are preferably generated with links to account specific reports to allow a user to easily access and review the underling data. A preferred set of linked reports is shown in FIG. 16. A Tools link 106 provides a menu to interactive applications, such as customized risk and scenario analysis, multi-period return attribution and variance analysis, exposure attribution and company risk analysis.

On the left of the home page screen are portals to a variety of utilities 110. These utilities provide access to specific reports in accordance with an entered client account number.

The center of the screen 112 contains summary information on selected benchmark portfolios. For example, in the sample image, the Frank Russell 1000 Growth index (FR1000 Growth) was down 17.62% year-to-date and was up 1.46% from the previous day. Each benchmark name is preferably hyperlinked to an underlying report, such as a QTD return attribution report for the respective portfolio which details the sources of the benchmark's total return by asset, sector, industry and investment style.

To the right of center, adjacent to the benchmark summary data, is risk information 114 for each benchmark portfolio. Preferably, this risk information is presented in the form of cross-sectional volatility. Shown in this embodiment are five-day averages of one-day cross-sectional volatility estimates. Adjacent to them are one- and three-month changes in the estimates. Hyperlinks from the volatility values to a daily risk decomposition report for the benchmark portfolio are preferably provided. The right-side of the web page 116 can be used to indicate summaries of the risk and return in broad market indices, provide news summaries, make announcements related to developments of the PACE platform, or for other purposes.

Particular methods for implementing various aspects of the invention have been discussed above. However, these methods should be considered as examples and various changes in the form and scope of the system can be made without departing from the spirit and scope of the invention.

1. A system for verifying the integrity of a set of data used to evaluate attributes of data groups:
a data warehouse comprising at least one database and storing a current set of data;
a diagnostics module configured to compare the current set of data with historical data to generate diagnostic data and to generate at least one diagnostic report based on the diagnostic data, wherein data points in the diagnostic report have associated data edit links;
a data edit module in communication with the data warehouse and configured to query a user to enter a new value for a specified data point and set the value of the specified data point in the data warehouse to the new value;
each data edit link configured to activate the data edit module upon the selection by a user and indicate to the data edit module the data point associated with the respective data edit link.

2. The system of claim 1, wherein the data warehouse contains an estimated value derived from the set of data for an attribute; the system further comprising:
a return model validation module in communication with the data warehouse, receiving a benchmark value for the attribute as input, and configured to store a difference value derived from comparing the estimated attribute value with the benchmark attribute value;
the diagnostic report comprises a report indicating the difference value.

3. A method for analyzing the attributes of a plurality of data groups related to a set of data comprising the steps of:
providing a set of factors;
providing a set of models which model attributes of the data groupings, each model being dependent on at least one factor selected from the set of factors;
associating each data grouping with at least one model;
determining factor values for at least one of the factors in the set of factors on which the models associated with the data groups depend;
for each data group, evaluating an associated model using at least the determined factor values and the set of data to provide a value for the attribute modeled by the associated model; and
storing the attribute values.

4. The method of claim 3, wherein:
the set of data comprises financial data related to a plurality of financial instruments; and
the data groups comprise portfolios, each portfolio identifying at least one financial instrument from the plurality of financial instruments.

5. A method for analyzing a plurality of portfolios using financial data comprising the steps of:
providing a set of factors;
providing a set of models which model attributes of portfolios, each model being dependent on at least one factor selected from the set of factors;
associating each portfolio with at least one model;
determining factor values for at least a subset of factors in the set of factors on which the models associated with the portfolios depend;
for each portfolio, evaluating an associated model using at least the determined factor values and the financial data to provide a value for the attribute modeled by the associated mode; and
storing the attribute values.

6. The method of claim 5, wherein the set of models comprises at least one risk model and at least one performance model;
each portfolio being associated with at least one risk model and at least one performance model.

7. The method of claim 5, wherein the set of models comprises at least one performance model, a particular portfolio being associated with the performance model such that a performance value for the particular portfolio is determined during the evaluating step, the method further comprising the steps of:
receiving an alternative performance value for the particular portfolio; and
comparing the determined performance value with the alternative performance value.

8. The method of claim 7, further comprising the step of indicating a potential data integrity condition when the determined performance value and the alternative performance value differ by more than a predefined value.

9. The method of claim 7, wherein the performance model models portfolio return and the alternative performance value is an officially reported value for the return of the particular portfolio.

10. The method of claim 5, wherein each portfolio is associated with at least one model in accordance with an investment strategy reflected by the respective portfolio.

11. The method of claim 5, further comprising the steps of:
making the factor set available to a model development platform;
developing in the development platform a new model dependent on at least one factor selected from the set of factors; and
adding the new model to the set of models.

12. The method of claim 11, wherein each model in the set of models is defined as a model object having a format which is compatible with the model development platform.

13. The method of claim 5, further comprising the step of generating at least one report based upon the portfolio attribute values.

14. A system for analyzing portfolios using financial data comprising:
a factor library comprising a plurality of factors;
a model database comprising a set of model objects defining models for portfolio attributes, each model being dependent on at least one factor in the factor library;
a plurality of portfolio objects, each portfolio object configured to store at least one attribute to be determined for the respective portfolio, each portfolio object being associated with at least one model;
a factors determination module configured to determine factor values for at least a subset of factors in the factors library and store the factor values in a factor value database; and
a model evaluation module configured to evaluate models associated with a particular portfolio using at least the determined factor values and the financial data to provide a value for the attribute modeled by the associated mode and store the attribute values in the respective portfolio object for the particular portfolio.

15. The system of claim 14, further comprising a plurality of performance objects, each performance object being associated with a respective portfolio and being configured to store a historical time-series of at least the attribute to be determined for the associated portfolio;
the model evaluation module being further configured to add the determined factor values for the respective portfolio to the associated performance object.

16. The system of claim 14, wherein the set of model objects comprises objects defining at least one risk model and at least one performance model;
each portfolio object being associated with at least one risk model object and at least one performance model object.

17. The system of claim 14, wherein the set of models comprises at least one performance model object, a particular portfolio being associated with the performance model object, wherein the model evaluation module provides a performance value for the particular portfolio;
the system receiving as input an alternative performance valuation for the particular portfolio;
the system further comprising a model validation module configured to store a difference value derived from comparing the performance value with the alternative performance value.

18. The system of claim 17, further comprising a data integrity module configured to indicate a potential data integrity condition when a magnitude of the difference value exceeds a predefined value.

19. The system of claim 17, wherein the performance model object models portfolio return and the alternative performance value is an officially reported value for the return of the particular portfolio.

20. The system of claim 14, wherein each portfolio object and each model object has a unique ID, the association between portfolio objects and model objects being specified in a portfolio association table.

21. The system of claim 14, further comprising an interface module configured to allow data from the factor value database to be exported from a model development platform and to allow model objects to be imported to the model database from the model development platform.

22. The system of claim 14, further comprising a report generation module configured to generate at least one report based upon the portfolio attribute values.

23. A method for verifying the integrity of financial data used to evaluate portfolios comprising the steps of:
receiving current financial data from a data source;
storing the received data in a data warehouse;
generating at least one diagnostic report from the received data, the diagnostic report containing a data point and an embedded data edit link; and
upon selection of the embedded data edit link by a user, requesting input from the user specifying a new value for the data point and setting the value of the data point as stored in the data warehouse to the new value.

24. The method of claim 23, further comprising the steps of:
generating summary indicator values based on the current financial data;
the step of generating at least one diagnostic report further comprising generating a summary diagnostic report containing summary indicator values and an embedded link from a summary indicator value to a diagnostic report containing the data used to generate the summary indicator value.

25. The method of claim 23, wherein the at least one diagnostic report contains data indicating at least one of outlier data, cross-sectional volatility, and corporate actions.

26. The method of claim 23, wherein the at least one diagnostic report comprises a historical time series report for attributes associated with a security, each attribute having an embedded data edit link.

27. The method of claim 23, further comprising the steps of:
receiving an estimated portfolio return generated using data in the data warehouse;
receiving an official return for the portfolio;
the at least one diagnostic report comprising a report comparing the estimated portfolio return to the official portfolio return.

28. The method of claim 23, wherein the diagnostic report further comprises a data information link associated with data in the diagnostic report; the method further comprising the step of:
upon selection of the data information link by the user, returning research information related to the associated data in the diagnostic report, the returned data increasing the ability of the user to determine if the associated data is in error.

29. A method for verifying the integrity of financial data used to evaluate a portfolio comprising the steps of:
receiving current financial data from a data source including information about securities in the portfolio;
storing the received data in a data warehouse;
receiving an estimated return value for the portfolio determined using the data in the data warehouse;
receiving an official return value for the portfolio;
providing a diagnostic report comparing the official return value with the estimated return value, the comparison report containing a first embedded link associated with the portfolio;
upon selection of the first embedded link in the comparison report by a user, providing a constituent report indicating the securities comprising the portfolio and attributes of the securities, the constituent report containing second embedded links, each second embedded link associated with a particular security;
upon selection by the user of a second embedded link in the constituent report, providing a historical time series report for attributes of the security associated with the selected second embedded link, each attribute in the historical time series report having an embedded data edit link;
upon selection of an embedded data edit link by the user, requesting input from the user specifying a new value for the attribute associated with the selected data edit link, and setting the value of the attribute as stored in the data warehouse to the new value.

30. A method for verifying the integrity of financial data related to a plurality of securities comprising the steps of:
receiving current financial data from a data source including information about the plurality of securities;
storing the received data in a data warehouse;
comparing the current financial data with historical data to identify securities having outlier attributes;
providing a diagnostic report indicating the identified securities, each identified security having an associated first embedded link;
upon selection of a first embedded link by a user, providing a historical time series report for attributes of the security associated with the selected first embedded link, each attribute in the historical time series report having an embedded data edit link;
upon selection of an embedded data edit link by the user, requesting input from the user specifying a new value for the attribute associated with the selected data edit link, and setting the value of the attribute as stored in the data warehouse to the new value.

31. The method of claim 30, wherein each identified security in the diagnostic report has an associated second embedded link;
the method further comprising the step of, upon selection of a second embedded link by the user; providing research information related to the security associated with the selected second embedded link, the research information increasing the ability of the user to determine if the attribute data for the particular security is in error.

32. A system for verifying the integrity of financial data used to evaluate portfolios comprising:
a data warehouse comprising at least one database and storing current financial data;
a diagnostics module configured to compare the current financial data with historical financial data to generate diagnostic data and to generate at least one diagnostic report based on the diagnostic data, wherein data points in the diagnostic report have associated data edit links;
a data edit module in communication with the data warehouse and configured to query a user to enter a new value for a specified data point and set the value of the specified data point in the data warehouse to the new value;
each data edit link configured to activate the data edit module upon the selection by a user and indicate to the data edit module the data point associated with the respective data edit link.

33. The system of claim 32, wherein the data warehouse contains an estimated performance value for a portfolio; the system further comprising:
a return model validation module in communication with the data warehouse, receiving an alternative performance value for the portfolio as input, and configured to store a difference value derived from comparing the performance value with the alternative performance value.

34. The system of claim 33, wherein the at least diagnostic report comprises a report comparing the alternative performance return value with the estimated performance value.

35. The system of claim 34, wherein the estimated performance value is an estimated return for the portfolio and the alternative portfolio is officially reported return value for the portfolio.

36. The system of claim 34, further comprising an analyitics module in communication with the data warehouse and configured to determine the estimated performance value for the and store the estimated performance value in the data warehouse.
